(19) United States
(12) Patent Application Publication
(10) Pub. No.: US 2025/0212041 A1
(43) Pub. Date: Jun. 26, 2025

(54) INFORMATION TRANSCEIVING METHOD AND APPARATUS

(71) Applicant: FUJITSU LIMITED, Kawasaki-shi (JP)

(72) Inventors: Gang SUN, Beijing (CN); Xin WANG, Beijing (CN)

(73) Assignee: FUJITSU LIMITED, Kawasaki-shi (JP)

(21) Appl. No.: 19/079,846

(22) Filed: Mar. 14, 2025

Related U.S. Application Data
(63) Continuation of application No. PCT/CN2022/120272, filed on Sep. 21, 2022.

(51) Int. Cl. H04W 24/10; H04L 5/00; H04L 41/16; H04W 72/231

(52) U.S. Cl. CPC H04W 24/10; H04L 5/0051; H04L 41/16; H04W 72/231

(57) ABSTRACT

An information transceiving apparatus, applicable to a network device, includes: a first transmitter configured to transmit first reporting configuration information to a terminal equipment, the first reporting configuration information comprising a first number of measurement results included in a measurement report, and/or, first relevant information of a first reference signal set to which a part of measurement results to be reported correspond, and/or, a first time interval for transmitting an aperiodic measurement report; and a first receiver configured to receive a measurement report transmitted by the terminal equipment.

### CROSS-REFERENCE TO RELATED APPLICATION

This application is a continuation application of International Application PCT/CN2022/120272 filed on Sep. 21, 2022, and designated the U.S., the entire contents of which are incorporated herein by reference.

### TECHNICAL FIELD

This disclosure relates to the field of communication technologies.

### BACKGROUND

As low-frequency spectrum resources become scarce, millimeter wave bands are able to provide greater bandwidths and have become important frequency bands for 5G NR (New Radio) systems. As millimeter waves are relatively short in wavelengths and have propagation characteristics different from related low-frequency bands, such as higher propagation loss, and poor reflection and diffraction performances, etc., larger scales of antenna arrays are usually used to form shaped beams with greater gains, overcome propagation losses, and ensure system coverage. 5G NR standards have designed a series of solutions for beam management, including beam scanning, beam measurement, beam report, and beam indication, etc. However, when the number of receive and transmitting beams is relatively large, the payload and latency of the system will be greatly increased.

With the development of artificial intelligence (AI) technologies, applying the AI technologies to physical layers of wireless communication to solve difficulties of related methods has become a current technological direction. For the beam management, using AI models to predict a spatially optimal beam pair according to results of measurement of a small number of beams may significantly reduce the payload and latency of the system.

It should be noted that the above description of background is merely provided for clear and complete explanation of this disclosure and for easy understanding by those skilled in the art. And it should not be understood that the above technical solution is known to those skilled in the art as it is described in the background of this disclosure.

### SUMMARY

Assuming that a transmitting end of a communication system has M beams and a receiving end thereof has N beams, in existing standards, it is needed to measure M*N beams. When the numbers of M and N are relatively large, measuring M*N beams results in a relatively large system payload and relatively long latency. Using models (such as AI models) to predict an optimal beam pair with results of measurement of a small number of beams may greatly reduce the system payload and latency caused by the beam measurement.

If an AI model is deployed at a network device side, the network device configures reference signals (CSI-RSs or SSBs) for beam measurement, and transmits the reference signals to the terminal equipment via different downlink transmitting beams for beam measurement, and the terminal equipment takes results of measurement as data (label data) for AI model training to the network device.

It was found by the inventors that when M and N are relatively large, the load of uplink reporting is relatively high. When the measurement results are fed back to the network device via uplink channels, as uplink channel resources are limited, it is necessary to consider how to carry a large amount of data needed in AI model training or inference by the limited uplink channels. On the other hand, due to changes in communication environments, a currently-used model needs to be updated, hence, the data needed in training or inference should be updated. However, there exists currently no solution for how to report the updated data.

In order to solve at least one of the above problems, embodiments of this disclosure provide an information transceiving method and apparatus.

According to one aspect of the embodiments of this disclosure, there is provided an information transceiving apparatus, applicable to a terminal equipment, the apparatus including:
a second receiving unit configured to receive first reporting configuration information transmitted by a network device, the first reporting configuration information including a first number of measurement results included in a measurement report, and/or, first relevant information of a first reference signal set to which a part of measurement results to be reported correspond, and/or, a first time interval for transmitting an aperiodic measurement report; and
a second transmitting unit configured to transmit the measurement report to the network device.

According to another aspect of the embodiments of this disclosure, there is provided an information transceiving apparatus, applicable to a network device, the apparatus including:
a first transmitting unit configured to transmit first reporting configuration information to a terminal equipment, the first reporting configuration information including a first number of measurement results included in a measurement report, and/or, first relevant information of a first reference signal set to which a part of measurement results to be reported correspond, and/or, a first time interval for transmitting an aperiodic measurement report; and
a first receiving unit configured to receive a measurement report transmitted by the terminal equipment.

According to a further aspect of the embodiments of this disclosure, there is provided a communication system, including a terminal equipment and/or a network device, the terminal equipment including the information transceiving apparatus as described in the one aspect, and the network device including the information transceiving apparatus as described in the other aspect.

An advantage of the embodiments of this disclosure exists in that the first number of measurement results included in the measurement report, and/or first relevant information of a first reference signal set to which a part of measurement results to be reported correspond, and/or a first time interval for transmitting an aperiodic measurement report, are configured for the terminal equipment, so that the terminal equipment is able to carry a part of the measurement results on the uplink channels in one time of measurement reporting feedback, thereby lowering the load of the uplink measurement feedback.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/including/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a communication system of embodiments of this disclosure;

FIG. 2 is a schematic diagram of a transmitting beam and a receiving beam in the communication system of the embodiments of this disclosure;

FIG. 3 is a schematic diagram of the information transceiving method of embodiments of this disclosure;

FIGS. 4-7 are schematic diagrams of first reporting configuration information of the embodiments of this disclosure;

FIG. 8 is a schematic diagram of the information transceiving method of embodiments of this disclosure;

FIG. 9 is a schematic diagram of the information transceiving method of embodiments of this disclosure;

FIG. 10 is a schematic diagram of the information transceiving method of embodiments of this disclosure;

FIG. 11 is a schematic diagram of the information transceiving method of embodiments of this disclosure;

FIG. 12 is a schematic diagram of an information transceiving apparatus of embodiments of this disclosure;

FIG. 13 is a schematic diagram of an information transceiving apparatus of embodiments of this disclosure;

FIG. 14 is a schematic diagram of the network device of embodiments of this disclosure; and

FIG. 15 is a schematic diagram of the terminal equipment of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, new radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipment described above. “A device” may refer to a network device, and may also refer to a terminal equipment, except otherwise specified.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

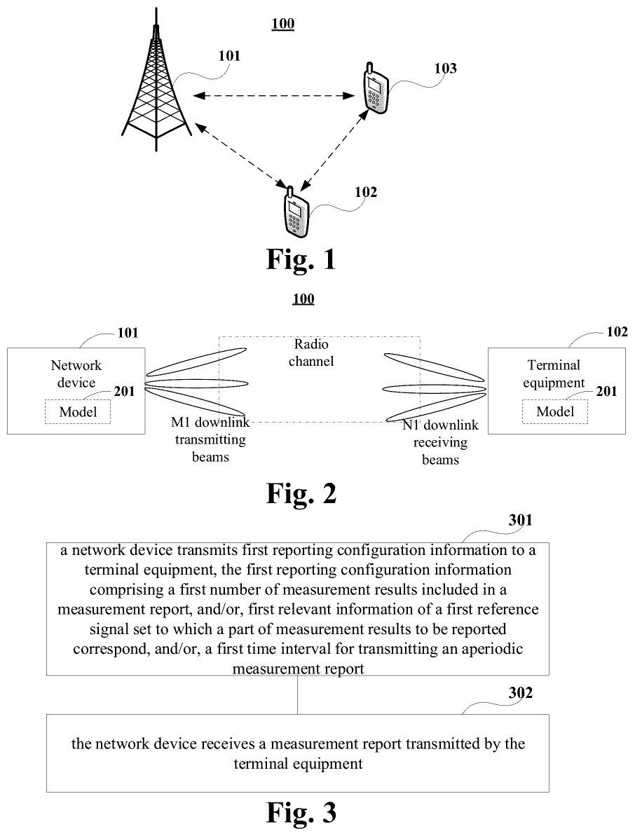

FIG. 1 is a schematic diagram of a communication system of embodiments of this disclosure, in which a case where terminal equipments and a network device are taken as examples is schematically shown. As shown in FIG. 1, a communication system 100 may include a network device 101 and terminal equipments 102, 103. For the sake of simplicity, an example having only two terminal equipments and one network device is schematically given in FIG. 1; however, the embodiment of this disclosure is not limited thereto.

In the embodiment of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

The terminal equipment 102 may transmit data to the network device 101, such as in a granted or grant-free transmission manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

It should be noted that FIG. 1 shows that two terminal equipments 102, 103 are both in coverage of the network device 101. However, this disclosure is not limited thereto, and the two terminal equipments 102, 103 may not be in coverage of the network device 101, or one terminal equipment 102 is in coverage of the network device 101 and the other terminal equipment 103 is out of coverage of the network device 101.

An AI model (or an ML model) includes but is not limited to an input layer (input), multiple convolutional layers, a concatenation layer (concat), a fully connected layer (FC), and a quantizer, etc., and processing results of the multiple convolutional layers are merged in the concatenation layer. Reference may be made to existing techniques for a specific structure of the AI model, which shall not be repeated herein any further.

FIG. 2 is a schematic diagram of a transmitting beam and a receiving beam in the communication system of the embodiments of this disclosure. As shown in FIG. 2, in the communication system 100, taking a downlink channel as an example, the network device 101 may have M1 downlink transmitting beams DL TX, and the terminal equipment 102 may have N1 downlink receiving beams DL RX.

In the embodiments of this disclosure, as shown in FIG. 2, a model 201 for predicting a beam measurement result may be deployed in the network device 101 or the terminal equipment 102. The model 201 may predict measurement results of M1*N1 beams according to measurement results of a part of beams. The model 201 may be, for example, an AI model, and may be deployed in the network device 101 or the terminal equipment 102.

In addition, for an uplink channel, the network device 101 may have N2 uplink receiving beams (not shown in FIG. 2), and the terminal equipment 102 may have M2 uplink transmitting beams UL TX (not shown in FIG. 2).

In order to solve the above problems, embodiments of this disclosure provide an information transceiving method and apparatus, which shall be described below with reference to the accompanying drawings and embodiments.

### Embodiments of a First Aspect

The embodiments of this disclosure provide an information transceiving method, which shall be described from a network device side, an AI model being deployed at the network device side.

FIG. 3 is a schematic diagram of the information transceiving method of the embodiments of this disclosure. As shown in FIG. 3, the method includes:
301: a network device transmits first reporting configuration information to a terminal equipment, the first reporting configuration information including a first number of measurement results included in a measurement report, and/or, first relevant information of a first reference signal set to which a part of measurement results to be reported correspond, and/or, a first time interval for transmitting an aperiodic measurement report; and
302: the network device receives a measurement report transmitted by the terminal equipment.

It should be noted that FIG. 3 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

With the above embodiments, the first number of measurement results included in the measurement report, and/or first relevant information of a first reference signal set to which a part of measurement results to be reported correspond, and/or a first time interval for transmitting an aperiodic measurement report, are configured for the terminal equipment, so that the terminal equipment is able to carry a part of the measurement results on the uplink channels in one time of measurement reporting feedback, thereby lowering the load of the uplink measurement feedback.

In some embodiments, the network device may transmit the measurement resource configuration information to the terminal equipment, including reference signals. The measurement resources (reference signals) may be, for example, CSI-RSs and/or SSBs, etc. For example, the configured measurement resources are a resource set list (a reference signal set), each resource set consisting of one or more measurement resources (reference signals), in other words, the network device may configure more than one reference signal for the terminal equipment for beam measurement, and the measurement resource configuration information includes a reference signal set identifier (measurement resource set identifier) and an identifier/identifiers of one or more measurement resources (reference signals) constituting the reference signal set (measurement resources). For example, the measurement resource configuration information may be expressed by an information element NZP-CSI-RS-ResourceSet or CSI-SSB-ResourceSet; however, these are examples only, and the embodiments of this disclosure are not limited thereto.

In some embodiments, the network device may further transmit second reporting configuration information, which is used to configure parameters needed by measurement reporting of the terminal equipment. For example, the second reporting configuration information includes second relevant information of a reference signal set corresponding to the measurement results to be reported. Optionally, the second reporting configuration information may further include a report quantity, and a report configuration type, etc. For example, when beam management is needed, the report quantity is a combination of the following parameters: CRI-RSRP/SINR (CSI-RS based beam management) or SSBRI-RSRP/SINR (SSB-based beam management). For example, the second reporting configuration information may be expressed by an information element CSI-ReportConfig; however, this is an example only, and the embodiments of this disclosure are not limited thereto. CSI-ReportConfig may be expressed as follows by using an ASN.1 data format:

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

```
  (1..maxNrofBWPs)) OF PUCCH-CSI-Resource
      },
```

| | |
|---|---|
| semiPersistentOnPUCCH | SEQUENCE { |
| reportSlotConfig | CSI- |
| ReportPeriodicityAndOffset, | |
| pucch-CSI-ResourceList | SEQUENCE (SIZE |

```
  (1..maxNrofBWPs)) OF PUCCH-CSI-Resource
      },
```

| | |
|---|---|
| semiPersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |
| reportSlotOffsetList | SEQUENCE (SIZE |

```
  (1..maxNrofUL-Allocations)) OF INTEGER(0..32)
      }
  },
  ......
-- TAG-CSI-REPORTCONFIG-STOP
-- ASN1STOP
```

where, reportConfigId denotes an identifier to which the reporting configuration corresponds, resourcesForChannelMeasurement denotes the second relevant information of the resources (reference signal set) to the measurement results to be reported correspond (for example, the second relevant information is a measurement resource configuration identifier CSI-ResourceConfigId, which is used to indicate the measurement resource configuration to determine a corresponding reference signal set identifier nzp-CSI-RS-ResourceSetId or csi-SSB-ResourceSetId), and reportConfigType is the report configuration type, including periodic, semi-Persistent semiPersistentOnPUCCH/semiPersistentOnPUSCH, and aperiodic types. In the second reporting configuration information, one of the periodic type, semi-Persistent type and the aperiodic type is configured, each reporting configuration type including time-frequency resource related information used by the measurement report.

In some embodiments, after the measurement resource configuration information and the second reporting configuration information are configured, the network device may transmit the reference signal set to be measured (the reference signals configured in the measurement resource configuration information) and such information as time-frequency resources and periods, etc. configured by the network device in the measurement resource configuration information, to the terminal equipment, and transmits a corresponding reference signal set on corresponding time-frequency resources, so that the terminal equipment performs beam measurement on the received reference signals.

In some embodiments, the network device may further transmit first reporting configuration information, the first reporting configuration information being used to indicate the terminal equipment, time units on which the measurement results are reported, and/or how many reference signals' corresponding measurement results to be reported, and/or which reference signals' corresponding measurement results to be reported. The first reporting configuration information may or may not be included in the above second reporting configuration information, and includes the first number of measurement results included in the measurement report, and/or the first relevant information of the first reference signal set corresponding to a part of measurement results to be reported, and/or a first time interval for transmitting aperiodic measurement reports. The first reporting configuration information may be carried by RRC and/or an MAC CE and/or DCI.

In some implementations, the network device may configure the terminal equipment with such reporting configuration information as the first number of measurement results included in the measurement report, and/or the first relevant information of the first reference signal set corresponding to the part of the measurement results to be reported, and/or the first time interval for transmitting the aperiodic measurement report, and the terminal equipment carries parts of the measurement results by more than one time unit respectively according to the reported configuration information (hereinafter referred to as time-division feedback). Hence, all measurement results may be fed back in a time-division manner on resource-limited uplink channels, and a load of uplink measurement feedback may be lowered.

In some implementations, the network device may configure the first relevant information of the first reference signal set corresponding to the part of the measurement results to be reported for the terminal equipment, that is, the network device configures the terminal equipment with information on the measurement results corresponding to the part of reference signals needed by the network device, and the terminal equipment reports the measurement results corresponding to the first reference signal set (hereinafter referred to as partial feedback) only, with no need of reporting the measurement results corresponding to all the reference signals, thereby further lowering the load of uplink measurement feedback.

The above two implementations shall be described below respectively. It should be noted that names of the following fields, data types and value ranges are examples only, and the embodiments of this disclosure are not limited thereto.

(I) Time-Division Feedback, Wherein the Terminal Equipment Carries the Part of Measurement Results by More than One Time Unit Respectively

In some implementations, the network device may configure the terminal equipment with such reporting configuration information as the first number of measurement results included in the measurement report, and/or the first relevant information of the first reference signal set corresponding to the part of measurement results to be reported, and/or the first time interval for transmitting aperiodic measurement reports.

The first number NumofMeasurementperReport (N1) of measurement results included in the measurement report is used to determine the number N of measurement results included in the measurement report reported by the terminal equipment in each time unit, and may also be referred to as the number of reference signals to which the measurement results included in the measurement report correspond, or the number of (reference signals corresponding to) downlink transmitting beams corresponding to the measurement results included in the measurement report, or the number of beam pairs corresponding to the measurement results included in the measurement report. There exists a correspondence between the downlink transmitting beams and the reference signals, and in some cases, the measurement results to which the downlink transmitting beams correspond and the measurement results to which the reference signals correspond are interchangeable, and reference may be made to the related art for details, which shall not be repeated herein any further. For example, N1=N (in the following examples, N1=N is taken as an example), or N1=2N, etc., and the embodiments of this disclosure are not limited thereto. The time unit may be a slot, or a symbol in the time domain, or a subframe, etc., and the embodiments of this disclosure are not limited thereto.

The first relevant information of the first reference signal set to which the measurement results to be reported correspond is used to determine the reference signals to which the measurement results included in the measurement report reported on each time unit correspond, and includes a starting position startIndexofCSI-RS-Resourceset (S1) of a sequence number of the first reference signal set in the reference signal set. The first reference signal in the first reference signal set is one or more reference signals in the reference signal set (a reference signal set indicated by second relevant information in the second reporting configuration information).

The first time interval TimeInterval for transmitting the aperiodic measurement report is used to determine an interval (time offset) between neighboring time units. The first time interval may take the above time unit as a unit indication, such as indicating how many time units in the interval; however, the embodiments of this disclosure are not limited thereto.

In some embodiments, the first reporting configuration information may be taken as a newly-added information element and included in existing RRC signaling (such as the second reporting configuration information), and may be newly-added RRC signaling or newly-added MAC CE signaling, or, a part of the first reporting configuration information may be taken as a newly-added information element and included in existing RRC signaling, and another part thereof may be newly-added RRC signaling or newly-added MAC CE signaling, or a part thereof may be newly-added RRC signaling, and another part thereof may be newly-added MAC CE signaling, which shall be respectively exemplified below.

For example, when the reporting configuration type is configured as being periodic or semi-Persistent in the second reporting configuration information, the first reporting configuration information may include the first number and/or the first relevant information, and the first reporting configuration information may be taken as a newly-added information element and included in the second reporting configuration information. Following is an example of the second reporting configuration information CSI-ReportConfig expressed by using an ASN.1 data format:

| -- ASN1START | |
|---|---|
| -- TAG-CSI-REPORTCONFIG-START | |
| CSI-ReportConfig ::= | SEQUENCE { |
| reportConfigId | CSI-ReportConfigId, |
| carrier | ServCellIndex |
| OPTIONAL, -- Need S | |
| resourcesForChannelMeasurement | CSI-ResourceConfigId, |
| csi-IM-ResourcesForInterference | CSI-ResourceConfigId |
| OPTIONAL, -- Need R | |
| nzp-CSI-RS-ResourcesForInterference | CSI-ResourceConfigId |
| OPTIONAL, -- Need R | |
| reportConfigType | CHOICE { |
| periodic | SEQUENCE { |
| reportSlotConfig | CSI- |
| ReportPeriodicityAndOffset, | |
| pucch-CSI-ResourceList | SEQUENCE (SIZE |
| (1..maxNrofBWPs)) OF PUCCH-CSI-Resource | |
| NumofMeasurementperReport | INTEGER(1..63) |
| OPTIONAL, | |
| }, | |
| semiPersistentOnPUCCH | SEQUENCE { |
| reportSlotConfig | CSI- |
| ReportPeriodicityAndOffset, | |
| pucch-CSI-ResourceList | SEQUENCE (SIZE |
| (1..maxNrofBWPs)) OF PUCCH-CSI-Resource | |
| NumofMeasurementperReport | INTEGER(1..63) |
| OPTIONAL, | |
| }, | |
| semiPersistentOnPUSCH | SEQUENCE { |
| reportSlotConfig | ENUMERATED {sl5, |
| sl10, sl20, sl40, sl80, sl160, sl320}, | |
| reportSlotOffsetList | SEQUENCE (SIZE (1.. |
| maxNrofUL-Allocations)) OF INTEGER(0..32), | |
| p0alpha | P0-PUSCH- |
| AlphaSetId | |
| NumofMeasurementperReport | INTEGER(1..63) |
| OPTIONAL, | |
| }, | |
| aperiodic | SEQUENCE { |
| reportSlotOffsetList | SEQUENCE (SIZE |

```
  (1..maxNrofUL-Allocations)) OF INTEGER(0..32)
        }
  },
  ......
-- TAG-CSI-REPORTCONFIG-STOP
-- ASN1STOP
```

In the configuration information fields related to the periodic reporting and semi-Persistent reporting in the second reporting configuration information (periodic, semiPersistentOnPUCCH and semiPersistentOnPUSCH information fields in reportConfigType), a first number NumofMeasurementperReport of fields are added, with a data type of integers. Names, data types and value ranges of the above newly-added fields are illustrative only, and are not limited in the embodiments of this disclosure.

In this example, according to the first number, the second relevant information and the reporting period in the configuration information fields related to the periodic or semi-Persistent reporting, the terminal equipment may determine time units on which the measurement reports are transmitted and determine which downlink transmitting beams (reference signals) corresponds to the measurement results in the measurement report transmitted on each time unit. For example, the network device has 64 downlink transmitting beams, the terminal equipment has one downlink receiving beam, and the terminal equipment needs to measure and report measurement results. The reference signal set indicated by CSI-ResourceConfigId corresponding to resourcesForChannelMeasurement in CSI-ReportConfig contains 64 reference signals (respectively corresponding to different downlink transmitting beams, and reference may be made to the related art for a specific correspondence, which shall not be repeated herein any further). Assuming that NumofMeasurementperReport=8 (the number of measurement results reported on one time unit) and a reporting period (which may determine an interval between neighboring time units) and reporting resources within each time unit are configured in periodic, semiPersistentOnPUCCH and semiPersistentOnPUSCH, a first one of measurement reports on a first one of time units (a time unit where the reporting resource is located) contains measurement results of downlink transmitting beams 0-7 (a reference signal with a smallest sequence number in reference signals indicated by the second relevant information is taken as a start by default), and a second one of measurement reports on a second one of time units (determined according to the report period) contains measurement results of downlink transmitting beams 8-15, and so on. Eight measurement reports may be transmitted at eight time units, and each measurement report contains measurement results to which eight downlink transmitting beams correspond, thereby reporting measurement results to which 64 downlink transmitting beams correspond in a time-division manner.

For example, the first reporting configuration information in the above example may further include the starting position startIndexofCSI-RS-Resourceset (S1) of the sequence number of the first reference signal set in the reference signal set, indicating which downlink transmitting beams corresponds to measurement results in a time unit. Following is an example of the second reporting configuration information CSI-ReportConfig expressed by using an ASN.1 data format:

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource

| | |
|---|---|
| TdReportConfig | SEQUENCE{ |
| | NumofMeasurementperReport |
| INTEGER(0..63) | OPTIONAL, |
| | startIndexofCSI-RS-Resourceset |
| INTEGER(0..63) | OPTIONAL, |
| | } |

},

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource

| | |
|---|---|
| TdReportConfig | SEQUENCE{ |
| | NumofMeasurementperReport |
| INTEGER(0..63) | OPTIONAL, |
| | startIndexofCSI-RS-Resourceset |
| INTEGER(0..63) | OPTIONAL, |
| | } |

},

| | |
|---|---|
| semiPersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId

| | |
|---|---|
| TdReportConfig | SEQUENCE{ |
| | NumofMeasurementperReport |
| INTEGER(0..63) | OPTIONAL, |
| | startIndexofCSI-RS-Resourceset |
| INTEGER(0..63) | OPTIONAL, |
| | } |

},

| | |
|---|---|
| aperiodic | SEQUENCE { |
| reportSlotOffsetList | SEQUENCE (SIZE |

```
  (1..maxNrofUL-Allocations)) OF INTEGER(0..32)
        }
  },
  ......
-- TAG-CSI-REPORTCONFIG-STOP
-- ASN1STOP
```

In the configuration information fields related to the periodic reporting and semi-Persistent reporting in the second reporting configuration information (periodic, semiPersistentOnPUCCH and semiPersistentOnPUSCH information fields in reportConfigType), a field TdReportConfig (the second reporting configuration information) is added, including a first number field and a startIndexofCSI-RS-Resourceset field, with a data type of integers. A name, a data type and a value range of the above newly-added field are illustrative only, and are not limited in the embodiments of this disclosure.

In this example, according to the first number, the starting position and the reporting period in the related configuration information fields in the periodic or semi-Persistent reporting, the terminal equipment may determine time units on which the measurement reports are transmitted and determine which downlink transmitting beams (reference signals) corresponds to the measurement results in the measurement report transmitted on each time unit. For example, the network device has 64 downlink transmitting beams, the terminal equipment has one downlink receiving beam, and the terminal equipment needs to measure and report measurement results. The reference signal set indicated by CSI-ResourceConfigId corresponding to resourcesForChannelMeasurement in CSI-ReportConfig contains 64 reference signals (respectively corresponding to different downlink transmitting beams). Assuming that NumofMeasurementperReport=8 (the number of measurement results reported on one time unit), the starting position=1 and a reporting period (which may determine an interval between neighboring time units) and reporting resources within each time unit are configured in periodic, semiPersistentOnPUCCH and semiPersistentOnPUSCH, a first one of measurement reports on a first one of time units (a time unit where the reporting resource is located) contains measurement results of downlink transmitting beams 1-8, and a second one of measurement reports on a second one of time units (determined according to the report period) contains measurement results of downlink transmitting beams 9-16, and so on, until reporting of 64 measurement results is completed in a time-division manner.

For example, when the reporting configuration type is configured as being aperiodic in the second reporting configuration information, the first reporting configuration information may include the first number and the first time interval, and the first reporting configuration information may be taken as a newly-added information element and included in the second reporting configuration information. Following is an example of the second reporting configuration information CSI-ReportConfig expressed by using an ASN.1 data format:

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

```
  (1..maxNrofBWPs)) OF PUCCH-CSI-Resourc
        },
```

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

```
  (1..maxNrofBWPs)) OF PUCCH-CSI-Resource
        },
```

| | |
|---|---|
| semiPersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |
| reportSlotOffsetList | SEQUENCE (SIZE |

(1..maxNrofUL-Allocations)) OF INTEGER(0..32)

| | |
|---|---|
| TdReportConfig | SEQUENCE{ |
| | NumofMeasurementperReport |
| INTEGER(0..63) | OPTIONAL, |
| | TimeInvterval |
| INTEGER(0..319) | OPTIONAL, |
| | } |

```
        }
  },
  ......
-- TAG-CSI-REPORTCONFIG-STOP
-- ASN1STOP
```

In an aperiodic reporting related configuration information field in the second reporting configuration information (an aperiodic information field in reportConfigType), a TdReportConfig (first reporting configuration information) field is added, including the first number NumofMeasurementperReport and the first time interval TimeInterval, data types thereof being both integers. Optionally, the first time interval may also be of an enumeration type, its maximum value is determined by the number of reference signals in the measurement resources (illustrative), and a maximum time interval of the first time interval is 320 time units (illustrative). A name, a data type and a value range of the above newly-added field are illustrative only, and are not limited in the embodiments of this disclosure.

In this example, according to the first number, the first time interval and the second relevant information, the terminal equipment may determine time units on which the measurement reports are transmitted and determine which downlink transmitting beams (reference signals) corresponds to the measurement results in the measurement report transmitted on each time unit. For example, the network device has 64 downlink transmitting beams, the terminal equipment has one downlink receiving beam, and the terminal equipment needs to measure and report measurement results. The reference signal set indicated by CSI-ResourceConfigId corresponding to resourcesForChannelMeasurement in CSI-ReportConfig contains 64 reference signals (respectively corresponding to different downlink transmitting beams). Assuming that NumofMeasurementperReport=8 (the number of measurement results reported on one time unit) and the first time interval=2 slots, the first one of measurement reports on the first one of time units (the time unit where the reporting resource is located) contains measurement results of downlink transmitting beams 0-7 (a reference signal with a smallest sequence number in reference signals indicated by the second relevant information is taken as a start by default), and the second one of measurement reports on the second one of time units (determined according to the first time interval) contains measurement results of downlink transmitting beams 8-15, and so on, until reporting of 64 measurement results is completed in a time-division manner.

For example, the first reporting configuration information in the above example may further include (the starting position of) the first relevant information startIndexofCSI-RS-Resourceset (S1), indicating which downlink transmitting beams corresponds to measurement results in a time unit. Following is an example of the second reporting configuration information CSI-ReportConfig expressed by using an ASN.1 data format:

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

```
  (1..maxNrofBWPs)) OF PUCCH-CSI-Resourc
        },
```

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

```
  (1..maxNrofBWPs)) OF PUCCH-CSI-Resource
        },
```

| | |
|---|---|
| semiPersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |
| reportSlotOffsetList | SEQUENCE (SIZE |

(1..maxNrofUL-Allocations)) OF INTEGER(0..32)

| | |
|---|---|
| TdReportConfig | SEQUENCE { |
| | NumofMeasurementperReport |
| INTEGER(0..63) | OPTIONAL, |
| | startIndexofCSI-RS-Resourceset |
| INTEGER(0..63) | OPTIONAL, |
| | TimeInvterval |
| INTEGER(0..319) | OPTIONAL, |
| | } |

```
        }
  },
  ......
```

In an aperiodic reporting related configuration information field in the second reporting configuration information (an aperiodic information field in reportConfigType), a TdReportConfig (second reporting configuration information) field is added, including the first number, a startIndexofCSI-RS-Resourceset field and the first time interval TimeInterval, data types thereof being all integers. A name, a data type and a value range of the above newly-added field are illustrative only, and are not limited in the embodiments of this disclosure.

In this example, according to the first number, the starting position and the first time interval, the terminal equipment may determine time units on which the measurement reports are transmitted and determine which downlink transmitting beams (reference signals) corresponds to the measurement results in the measurement report transmitted on each time unit. For example, the network device has 64 downlink transmitting beams, the terminal equipment has one downlink receiving beam, and the terminal equipment needs to measure and report measurement results. The reference signal set indicated by CSI-ResourceConfigId corresponding to resourcesForChannelMeasurement in CSI-ReportConfig contains 64 reference signals (respectively corresponding to different downlink transmitting beams). Assuming that NumofMeasurementperReport=8 (the number of measurement results reported on one time unit), the starting position=1 and the first time interval=2 slots, the first one of measurement reports on the first one of time units (the time unit where the reporting resource is located) contains measurement results of downlink transmitting beams 1-8, and the second one of measurement reports on the second one of time units (determined according to the first time interval) contains measurement results of downlink transmitting beams 9-16, and so on, until reporting of 64 measurement results is completed in a time-division manner.

In the above example, the first reporting configuration information is included in the second reporting configuration information; however, the embodiments of this disclosure are not limited thereto. For example, the first reporting configuration information may also be newly-added signaling, and is not included in the second reporting configuration information, which shall be exemplified below.

For example, the above first reporting configuration information may be newly-added RRC signaling TdReportConfig. When the reporting configuration type is configured as being periodic or semi-Persistent in the second reporting configuration information, the newly-added RRC signaling may include the first number, or include the first number and the above starting position. When the reporting configuration type is configured as being aperiodic in the second reporting configuration information, the newly-added RRC signaling may include the first number and the first time interval, or include the first number, the above starting position and the first time interval. The fields, data types and value ranges thereof and how the terminal equipment reports the measurement report according to the first reporting configuration information and the second reporting configuration information are as described above, which shall not be repeated herein any further. When the first reporting configuration information is newly-added RRC signaling, the first reporting configuration information may further include a first reporting configuration identifier and/or a second reporting configuration identifier associated with the first reporting configuration. The first reporting configuration information and the second reporting configuration information may be associated according to the configuration identifier, thereby determining a second reporting configuration based on which the first reporting configuration is made for further reporting configuration. In the first reporting configuration information, an identifier of the reference signal set may further be included, which is used to indicate a reference signal set with which the above starting position is associated.

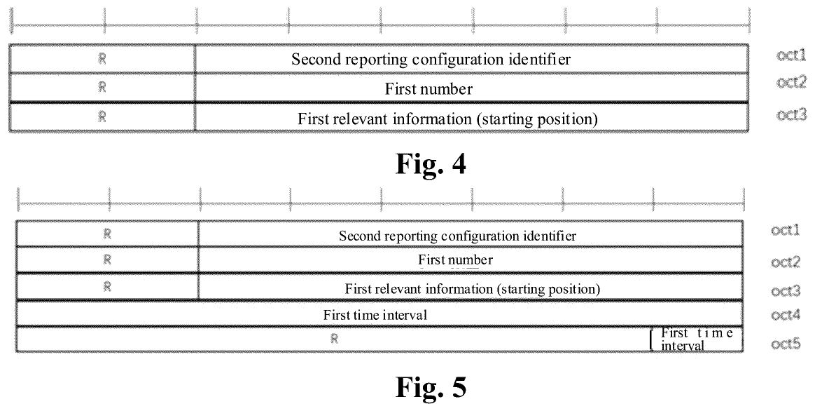

For example, the above first reporting configuration information may be newly-added MAC CE signaling, when the reporting configuration type is configured as being periodic or semi-Persistent in the second reporting configuration information, the newly-added MAC CE signaling may include the first number, or the first number and the above starting position, and when the reporting configuration type is configured as being aperiodic in the second reporting configuration information, the newly-added MAC CE signaling may include the first number and the first time interval, or the first number and the above starting position and the first time interval. The fields, data types and value ranges thereof and how the terminal equipment reports the measurement report according to the first reporting configuration information and the second reporting configuration information are as described above, which shall not be repeated herein any further. When the first reporting configuration information is newly-added MAC CE signaling, the first reporting configuration information may further include a first reporting configuration identifier and/or a second reporting configuration identifier associated with the first reporting configuration. The first reporting configuration information and the second reporting configuration information may be associated according to the configuration identifier, thereby determining a second reporting configuration based on which the first reporting configuration is made for further reporting configuration. FIG. 4 is a schematic diagram of the first reporting configuration information of the embodiments of this disclosure. As shown in FIG. 4, when the reporting configuration type is configured as being period or semi-Persistent in the second reporting configuration information, the MAC CE includes a second reporting configuration identifier (reportConfiguraId), the first number and/or the above starting position, for example, the second reporting configuration identifier is represented by a 6-bit values. The first number and the above starting position are also represented by 6-bit values; however, the embodiments of this disclosure are not limited thereto. FIG. 5 is a schematic diagram of the first reporting configuration information in the embodiments of this disclosure. As shown in FIG. 5, when the reporting configuration type is configured as being aperiodic in the second reporting configuration information, the MAC CE includes a second reporting configuration identifier (reportConfiguraId), the first number and/or the above starting position and/or the first time interval, for example, the second reporting configuration identifier is represented by a 6-bit values, the first number and the above starting position are also represented by 6-bit values, and the first time interval is represented by a 9-bit values; however, the embodiments of this disclosure are not limited thereto.

For example, a part of the above first reporting configuration information may be included in the newly-added MAC CE signaling, and another part thereof may be included in the newly-added RRC signaling, or a part of the first reporting configuration information may be included in the newly-added MAC CE signaling, and another part thereof may be in the second reporting configuration information, or a part of the first reporting configuration information may be included in the newly-added RRC signaling, and another part thereof may be in the second reporting configuration information; however, the embodiments of this disclosure are not limited thereto. For example, when the reporting configuration type is configured as being periodic or semi-Persistent in the second reporting configuration information and the first reporting configuration information includes the first number and the above starting position, the information field of the first number may be included in the second reporting configuration information (or the newly-added RRC signaling), and the information field of the starting position may be included in the MAC CE signaling; or, the information field of the starting position may be included in the second reporting configuration information (or the newly-added RRC signaling), and the information field of the first number may be included in the MAC CE signaling; or, the information field of the starting position may be included in the newly-added RRC signaling, and the information field of the first number may be included in the second reporting configuration information. For example, when the reporting configuration type is configured as being aperiodic in the second reporting configuration information, the first reporting configuration information may include the first number, the above starting position and the first time interval, and the information field of the first number may be included in the second reporting configuration information (or the newly-added RRC signaling), and the information fields of the starting position and the first time interval may be included in the MAC CE signaling; or, the information field of the starting position may be included in the second reporting configuration information (or the newly-added RRC signaling), and the information fields of the first number and the first time interval may be included in the MAC CE signaling; or, the information fields of the first number and the starting position may be included in the second reporting configuration information (or the newly-added RRC signaling), and the information field of the first time interval may be included in the MAC CE signaling; or, the information fields of the first number and the starting position may be included in the newly-added RRC signaling, and the information field of the first time interval may be included in the MAC CE signaling, which shall not be illustrated herein any further.

### (II) Partial Feedback

In some embodiments, it may also be that not all measurement results need to be fed back, and only a part of the measurement results is fed back. For example, as a currently-used model needs to be updated due to changes in the communication environment, data for model training need to be updated. At this time, not all the measurement results of the beams need to be updated. Therefore, the network device may inform the terminal equipment of which measurement results need to be updated via the first reporting configuration information, and the terminal equipment needs only to report measurement results needing to be updated according to the first reporting configuration information. Reference signals to which the measurement results needing to be updated correspond are hereinafter referred to as first reference signals, the first reference signals being one or more reference signals in the reference signal set.

In some embodiments, the network device may configure the terminal equipment with first relevant information of a first reference signal set to which a part of measurement results to be reported correspond, that is, the network device configures the terminal equipment with information on measurement results to which a part of reference signals needed thereby correspond. The first relevant information includes a starting position of sequence number of the first reference signal set in the reference signal set and interval information of the sequence number of the first reference signal set in the reference signal set, or a bitmap of the first reference signal set corresponding to the reference signal set.

In some embodiments, the first reporting configuration information may be taken as a newly-added information element and included in existing RRC signaling (such as the second reporting configuration information), and may be newly-added RRC signaling, or newly-added MAC CE signaling; or, a part of the first reporting configuration information may be taken as a newly-added information element and included in the existing RRC signaling, and another part thereof may be newly-added RRC signaling or newly-added MAC CE signaling, or a part thereof may be newly-added RRC signaling, and another part thereof may be newly-added MAC CE signaling. When the first reporting configuration information is newly-added signaling, the first reporting configuration information may further include the first relevant information and the reference signal set identifier, and/or first reporting configuration identifier, and/or second reporting configuration identifier associated with the first reporting configuration.

The following description shall be given by way of examples.

For example, the first reporting configuration information may be newly-added RRC signaling, and may include the starting position of the sequence number of the first reference signal set in the reference signal set and the interval information of the sequence number of the first reference signal set in the reference signal set. Following is an example of the first reporting configuration information CSI-Report-Subset-Config expressed by using an ASN.1 data format:

- ASN1START
-- TAG-CSI-REPORT-SUBSET-CONFIG-START

| | |
|---|---|
| CSI-Report-Subset-Config::= | SEQUENCE { |
| subsetreportConfigId | CSI-ReportSubsetConfigId |
| reportConfigId | CSI-ReportConfigId, --OPTIONAL |
| csi-reportsubset | CHOICE{ |
| csi-report-subset-nzp-CSI-RS | SEQUENCE{ |
| nzp-CSI-RS-ResourceSetId | NZP-CSI-RS-ResourceSetId |
| csi-report-subset | SEQUENCE { |
| startIndexofCSI-RS-Resourceset | INTEGER(0..63) |
| intervalofCSI-RS-Resoruceset | INTEGER(1..62) |

```
              }
      }
```

| | |
|---|---|
| csi-report-subset-CSI-SSB | SEQUENCE{ |
| csi-SSB-ResourceSetId | CSI-SSB-ResourceSetId |
| csi-report-subset | SEQUENCE { |
| startIndexofCSI-RS-Resourceset | INTEGER(0..63) |
| intervalofCSI-RS-Resoruceset | INTEGER(1..62) |

```
              }
      }
    }
}
-- TAG- CSI-REPORT-SUBSET-CONFIG -STOP
-- ASN1STOP
```

The first reporting configuration information RRC signaling CSI-Report-Subset-Config is newly added, including the first reporting configuration identifier (subsetreportConfigId), the associated second reporting configuration identifier (reportConfigId) and reference signal set identifier being used to indicate an ID (nzp-CSI-RS-ResourceSetId or csi-SSB-ResourceSetId) of the reference signal set in the resource configuration signaling to which the second relevant information resourcesForChannelMeasurement in the second reporting configuration corresponds and the starting position of the sequence number of the first reference signal set in the reference signal set and the interval information of the sequence number of the first reference signal set in the reference signal set (startIndexofCSI-RS-Resourceset+intervalofCSI-RS-Resoruceset), with a data type of integers, and its value range is determined by the number of reference signals in the reference signal set (with a maximum value of maxNrofNZP-CSI-RS-ResourcesPerSet or maxNrofCSI-SSB-ResourcePerSet). A field name, the data type and the value range of the above first reporting configuration information RRC signaling are illustrative only, and are not limited in the embodiments of this disclosure.

In this example, the terminal equipment determines a corresponding reference signal set according to the second reporting configuration identifier and the reference signal set identifier, then determines first reference signals in the first reference signal set according to the starting position of the sequence number of the first reference signal set in the reference signal set and the interval information of the sequence number of the first reference signal set in the reference signal set, and feeds back a part of measurement results to which the first reference signals (downlink transmitting beams) correspond, such as determining that the reference signal set indicated by CSI-ResourceConfigId of resourcesForChannelMeasurement in corresponding CSI-ReportConfig in correspondence to the second reporting configuration identifier contains 64 reference signals (corresponding respectively to different downlink transmitting beams). Assuming that the starting position is 0 and the interval information is 8, a measurement report is transmitted on a time unit (a time unit where the reporting resource is located), the measurement report including measurement results of downlink transmitting beams 0, 8, 16, 24, 32, 40, 48, 56 and 64, and there is no need to report measurement results to which all reference signals (downlink transmitting beams) correspond.

For example, the first reporting configuration information may be newly-added RRC signaling, and includes a bitmap of the first reference signal set corresponding to the reference signal set. Following is an example of the first reporting configuration information CS-Report-Subset-Config expressed by using an ASN.1 data format:

- ASN1START
-- TAG-CSI-REPORT-SUBSET-CONFIG-START

| | |
|---|---|
| CSI-Report-Subset-Config::= | SEQUENCE { |
| subsetreportConfigId | CSI-ReportSubsetConfigId |
| reportConfigId | CSI-ReportConfigId, --OPTIONAL |
| csi-reportsubset | CHOICE{ |
| csi-report-subset-nzp-CSI-RS | SEQUENCE{ |
| nzp-CSI-RS-ResourceSetId | NZP-CSI-RS-ResourceSetId |
| csi-report-subset | BIT STRING (size (maxNrofNZP- |

CSI-RS-ResourcesPerSet))
}

| | |
|---|---|
| csi-report-subset-CSI-SSB | SEQUENCE{ |
| csi-SSB-ResourceSetId | CSI-SSB-ResourceSetId |
| csi-report-subset | BIT STRING |

```
  (size(maxNrofCSI-SSB-ResourcePerSet))
      }
    }
}
-- TAG- CSI-REPORT-SUBSET-CONFIG -STOP
-- ASN1STOP
```

The first reporting configuration information RRC signaling CSI-Report-Subset-Config is newly added, including the first reporting configuration identifier (sub setreportConfigId), the associated second reporting configuration identifier (reportConfigId) and reference signal set identifier being used to indicate an TD (nzp-CSI-RS-Resource SetId or csi-SSB-Resource SetId) of the reference signal set in the resource configuration signaling to which the second relevant information resourcesForChannelMeasurement in the second reporting configuration corresponds and the bitmap (csi-report-subset) of the first reference signal set corresponding to the reference signal set, with a data type of bit sequence, and a length of the bitmap is determined by the number maxNrofNZP-CSI-RS-ResourcesPerSet or maxNrofCSI-SSB-ResourcePerSet of reference signals in the reference signal set. A bit value of 1 indicates that the measurement report needs to include a measurement result of a downlink transmitting beam corresponding to the reference signal to which the bitcorresponds, and a bit value of 0 indicates that the measurement report does not include a measurement result of a downlink transmitting beam corresponding to a reference signal to which the bit corresponds. A field name, the data type and the value range of the above first reporting configuration information RRC signaling are illustrative only, and are not limited in the embodiments of this disclosure.

In this example, the terminal equipment determines a corresponding reference signal set according to the second reporting configuration identifier and the reference signal set identifier, then determines first reference signals in the first reference signal set according to the bitmap of the first reference signal set corresponding to the reference signal set, and feeds back a part of measurement results to which the first reference signals (downlink transmitting beams) correspond, such as determining that the reference signal set indicated by CSI-ResourceConfigId of resourcesForChannelMeasurement in corresponding CSI-ReportConfig in correspondence to the second reporting configuration identifier contains 64 reference signals (corresponding respectively to different downlink transmitting beams). Assuming that the bitmap has 64 bits, 1000000100000001 . . . , a measurement report is transmitted on a time unit (a time unit where the reporting resource is located), the measurement report includes measurement results of downlink transmitting beams 0, 8, 16, . . . , and there is no need to report measurement results to which all reference signals (downlink transmitting beams) correspond.

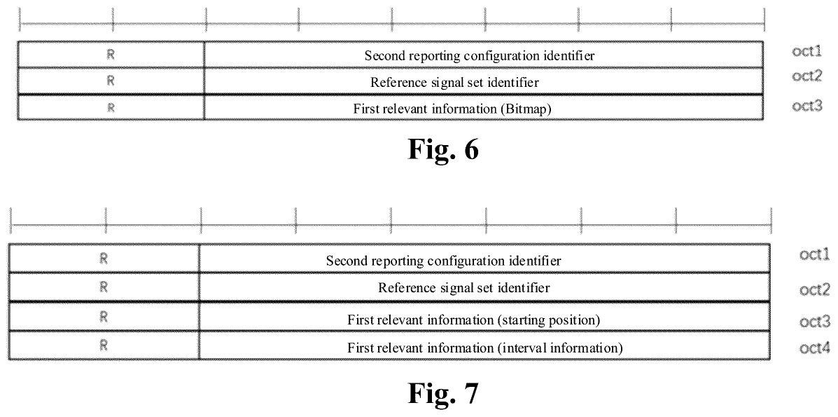

For example, the first reporting configuration information may be newly-added MAC CE signaling, and includes the starting position of the sequence number of the first reference signal set in the reference signal set and the interval information of the sequence number of the first reference signal set in the reference signal set. FIG. 6 is a schematic diagram of the first reporting configuration information in the embodiments of this disclosure. As shown in FIG. 6, first reporting configuration information MAC CE signaling is newly added, which includes a second reporting configuration identifier associated with the first reporting configuration identifier, a reference signal set identifier used to indicate an ID (nzp-CSI-RS-ResourceSetId or csi-SSB-ResourceSetId) of a reference signal set in resource configuration signaling to which the second relevant information resourcesForChannelMeasurement in the second reporting configuration corresponds, and a bitmap (csi-report-subset) of the first reference signal set corresponding to reference signal set, wherein a data type of the bitmap is a bit sequence, and a length of the bitmap is determined by the number maxNrofNZP-CSI-RS-ResourcesPerSet or maxNrofCSI-SSB-ResourcePerSet of reference signals in the reference signal set. A bit value of 1 indicates that the measurement report needs to include a measurement result of a downlink transmitting beam corresponding to the reference signal to which the bit corresponds, and a bit value of 0 indicates that the measurement report does not include a measurement result of a downlink transmitting beam corresponding to the reference signal to which the bit corresponds. The second reporting configuration identifier, the reference signal set identifier and the bitmap may be represented by 6 bits; however, the embodiments of this disclosure are not limited thereto. The terminal equipment transmits the measurement report to which the first reference signal corresponds on a time unit (a time unit where the reporting resource is located) according to the first reporting configuration information, and reference may be made to the above RRC signaling for specific implementation, which shall not be repeated herein any further.

For example, the first reporting configuration information may be newly-added MAC CE signaling, and includes a bitmap of the first reference signal set corresponding to the reference signal set. FIG. 7 is a schematic diagram of the first reporting configuration information in the embodiments of this disclosure. As shown in FIG. 7, the newly-added first reporting configuration information MAC CE signaling includes a second reporting configuration identifier associated with the first reporting configuration identifier, a reference signal set identifier used to indicate an ID (nzp-CSI-RS-ResourceSetId or csi-SSB-ResourceSetId) of the reference signal set in the resource configuration signaling to which the second relevant information resourcesForChannelMeasurement in the second reporting configuration corresponds, and the starting position of the sequence number of the first reference signal set in the reference signal set+the interval information of the sequence number of the first reference signal set in the reference signal set, with a data type of bit sequence, and its value range is determined by the number of reference signals in the reference signal set (with a maximum value of maxNrofNZP-CSI-RS-ResourcesPerSet or maxNrofCSI-SSB-ResourcePerSet). The second reporting configuration identifier, the reference signal set identifier, the starting position and the interval information may be represented by 6 bits; however, the embodiments of this disclosure are not limited thereto. The terminal equipment transmits the measurement report to which the first reference signal corresponds on a time unit (a time unit where the reporting resource is located) according to the first reporting configuration information, and reference may be made to the above RRC signaling for specific implementation, which shall not be repeated herein any further.

For example, the first reporting configuration information may also be a newly-added field/information element csi-report-subset, included in the second reporting configuration information, and may include the starting position of the sequence number of the first reference signal set in the reference signal set+the interval information of the sequence number of the first reference signal set in the reference signal set, or include the bitmap of the first reference signal set corresponding to the reference signal set. Following is example 1 of the second reporting configuration information CSI-ReportConfig expressed by using an ASN.1 data format, and the first reporting configuration information may include the starting position startIndexofCSI-RS-Resourceset of the sequence number of the first reference signal set in the reference signal set+the interval information intervalofCSI-RS-Resoruceset of the first reference signal set in the reference signal set:

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| csi-report-subset | SEQUENCE { |
| startIndexofCSI-RS-Resourceset | INTEGER(0..63) |
| intervalofCSI-RS-Resoruceset | INTEGER(1..62) |

}

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

```
  (1..maxNrofBWPs)) OF PUCCH-CSI-Resourc
      },
```

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

```
  (1..maxNrofBWPs)) OF PUCCH-CSI-Resource
      },
```

| | |
|---|---|
| semiPersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |
| reportSlotOffsetList | SEQUENCE (SIZE |

```
  (1..maxNrofUL-Allocations)) OF INTEGER(0..32)
      }
  },
  ......
```

Following is example 2 of the second reporting configuration information CSI-ReportConfig expressed by using an ASN.1 data format, and the first reporting configuration information includes the bitmap of the first reference signal set corresponding to the reference signal set:

-- ASN1START
-- TAG-CSI-REPORTCONFIG-START

| | |
|---|---|
| CSI-ReportConfig ::= | SEQUENCE { |
| reportConfigId | CSI-ReportConfigId, |

-

| | |
|---|---|
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| csi-report-subset | BIT STRING (size(maxNrofCSI-SSB- |

ResourcePerSet))

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

```
  (1..maxNrofBWPs)) OF PUCCH-CSI-Resourc
      },
```

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

```
  (1..maxNrofBWPs)) OF PUCCH-CSI-Resource
      },
```

| | |
|---|---|
| semiPersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |
| reportSlotOffsetList | SEQUENCE (SIZE |

```
(1..maxNrofUL-Allocations)) OF INTEGER(0..32)
      }
  },
  ......
```

In example 1 and example 2, reference may be made to the above newly-added signaling for meanings, value ranges, data types, etc. of the fields, and the terminal equipment transmits the measurement report to which the first reference signal corresponds on a time unit (a time unit where the reporting resource is located) according to the first reporting configuration information. Reference may be made to the above RRC signaling for specific implementation, which shall not be repeated herein any further.

In the above embodiments (the newly-added information element or the newly-added signaling), when the first reporting configuration information appears (for example, the second reporting configuration information includes the first reporting configuration information, or the newly-added RRC signaling or MAC CE signaling is configured), it indicates that the reported measurement result is applied in a scenario where an AI model is deployed, and the measurement result is used for AI-model-based beam management. And when the first reporting configuration information is not present (for example, the second reporting configuration information does not include the first reporting configuration information, or the newly-added RRC signaling or MAC CE signaling is not configured), the reported measurement result is applied in a scenario where no AI model is deployed, and the measurement result is used for legacy beam management.

The above (I) and (II) may be implemented separately or in a combined manner, and the embodiments of this disclosure are not limited thereto. For example, network devices may inform the terminal equipment of the part of measurement results needing to be updated, and the terminal equipment may transmit the part of the measurement results instead of the whole measurement results in a time-division manner. For example, the first reporting configuration information is newly-added RRC signaling CSI-Report-Subset-Config, which includes the first relevant information (such as a bitmap) of the first reference signal set corresponding to the part of measurement results to be reported, and furthermore, it may include the first number and/or the first time interval and/or the starting position; or, the first reporting configuration information TdReportConfig is included in the second reporting configuration information, and includes the first number and/or the first time interval, and furthermore, it may include the starting position startIndexofCSI-RS-Resourceset of the sequence number of the first reference signal set in the reference signal set+the interval information of the sequence number of the first reference signal set in the reference signal set, or include the bitmap of the first reference signal set corresponding to the reference signal set. However, this is illustrative only, and the embodiments of this disclosure are not limited thereto.

In addition, that the network device configures the terminal equipment with a reference signal set is taken as an example above; however, this disclosure is not limited thereto. In group-based report, the network device configures more than one reference signal set for the terminal equipment, and the network device may configure corresponding first reporting configuration information (such as the first number, the first relevant information, and/or the first time interval, etc.) for each reference signal set. The above information configured for different reference signal sets may be identical or different, and the embodiments of this disclosure are not limited thereto. Configuring methods for the reference signal set are similar, and details are as described above, which shall not be repeated herein any further.

In some embodiments, in 302, the terminal equipment may determine measurement results included in a measurement report transmitted on a time unit. And the measurement results are determined by corresponding first reference signals according to the above first reporting configuration information, the measurement report being carried by UCI. In order to further reduce a payload of uplink feedback, the reported measurement report may include a measurement result only, such as L1-RSRP or SINR, which may be an absolute value, or a differential value relative to a certain measurement result (such as measurement result #1, and optionally, including group #1). In addition, the measurement report does not include relevant information (such as identification information) of a downlink transmitting beam and/or a downlink receiving beam. The more than one measurement result may be sorted in a predetermined order, which includes an order of downlink transmitting beam identifiers first, and then downlink receiving beam identifiers, or an order of downlink receiving beam identifiers first, and then downlink transmitting beam identifiers; however, the embodiments of this disclosure are not limited thereto. The network device receives the measurement results reported by the terminal equipment, and the measurement results are used for inference or training of an AI model.

For example, the number of downlink receiving beams of the terminal equipment is 2, receiving beam #0 and receiving beam #1, and the number of downlink transmitting beams thereof is 4, transmitting beam #0, transmitting beam #1, transmitting beam #2, and transmitting beam #3, assuming that the first number included in the first reporting configuration information is 8, a measurement report transmitted on one time unit may include 8 measurement results, without needing to include identifiers of the downlink transmitting beams and the downlink receiving beams. The 8 measurement results are arranged in an order of the identifiers of the downlink transmitting beams first and then the identifiers of the downlink receiving beams (i.e. fixing identical receiving beams first and then arranging the transmitting beams in sequence), as shown in Table 1 below, or are arranged in an order of the identifiers of the downlink receiving beams first and then the identifiers of the downlink transmitting beams (i.e. fixing identical transmitting beams first and then arranging the receiving beams in sequence), as shown in Table 2 below.

TABLE 1

Measurement result #1 (transmitting beam #0, receiving beam #0)
Measurement result #2 (transmitting beam #1, receiving beam #0)
Measurement result #3 (transmitting beam #2, receiving beam #0)
Measurement result #4 (transmitting beam #3, receiving beam #0)
Measurement result #5 (transmitting beam #0, receiving beam #1)
Measurement result #6 (transmitting beam #1, receiving beam #1)
Measurement result #7 (transmitting beam #2, receiving beam #1)
Measurement result #8 (transmitting beam #3, receiving beam #1)

TABLE 2

Measurement result #1 (transmitting beam #0, receiving beam #0)
Measurement result #2 (transmitting beam #0, receiving beam #1)
Measurement result #3 (transmitting beam #1, receiving beam #0)
Measurement result #4 (transmitting beam #1, receiving beam #1)
Measurement result #5 (transmitting beam #2, receiving beam #0)
Measurement result #6 (transmitting beam #2, receiving beam #1)
Measurement result #7 (transmitting beam #3, receiving beam #0)
Measurement result #8 (transmitting beam #3, receiving beam #1)

In some embodiments, in group-based report, the terminal equipment may receive 2 beams simultaneously, hence, the network device may configure 2 reference signal sets for the terminal. Assuming that the number of downlink receiving beams of the terminal equipment is 2, and the first number configured by the network device for each reference signal set in the first reporting configuration information is 6, and at the same time, assuming that transmitting beam identifiers in each reference signal set are all #1, #2 and #3, there are total 6 groups in the measurement report, with 2 measurement results per group corresponds 2 reference signal sets, and the measurement report may further include a reference signal set indication. Two measurement results in each group are arranged in an order of the identifiers of the downlink transmitting beams first and then the identifiers of the downlink receiving beams (i.e. fixing identical receiving beams first and then arranging the transmitting beams in sequence), as shown in Table 3 below, or are arranged in an order of the identifiers of the downlink receiving beams first and then the identifiers of the downlink transmitting beams (i.e. fixing identical transmitting beams first and then arranging the receiving beams in sequence), as shown in Table 4 below.

TABLE 3
Reference signal set indication

Measurement result #1, group #1 (transmitting beam #1, receiving beam #0)
Measurement result #2, group #1 (transmitting beam #1, receiving beam #0)
Measurement result #1, group #2 (transmitting beam #2, receiving beam #0)
Measurement result #2, group #2 (transmitting beam #2, receiving beam #0)
Measurement result #1, group #3 (transmitting beam #3, receiving beam #0)
Measurement result #2, group #3 (transmitting beam #3, receiving beam #0)
Measurement result #1, group #4 (transmitting beam #1, receiving beam #1)
Measurement result #2, group #4 (transmitting beam #1, receiving beam #1)
Measurement result #1, group #5 (transmitting beam #2, receiving beam #1)
Measurement result #2, group #5 (transmitting beam #2, receiving beam #1)
Measurement result #1, group #6 (transmitting beam #3, receiving beam #1)
Measurement result #2, group #6 (transmitting beam #3, receiving beam #1)

TABLE 4
Reference signal set indication

Measurement result #1, group #1 (transmitting beam #1, receiving beam #0)
Measurement result #2, group #1 (transmitting beam #1, receiving beam #0)
Measurement result #1, group #2 (transmitting beam #1, receiving beam #1)
Measurement result #2, group #2 (transmitting beam #1, receiving beam #1)
Measurement result #1, group #3 (transmitting beam #2, receiving beam #0)
Measurement result #2, group #3 (transmitting beam #2, receiving beam #0)
Measurement result #1, group #4 (transmitting beam #2, receiving beam #1)
Measurement result #2, group #4 (transmitting beam #2, receiving beam #1)
Measurement result #1, group #5 (transmitting beam #3, receiving beam #0)
Measurement result #2, group #5 (transmitting beam #3, receiving beam #0)
Measurement result #1, group #6 (transmitting beam #3, receiving beam #1)
Measurement result #2, group #6 (transmitting beam #3, receiving beam #1)

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiments, the first number of measurement results included in the measurement report, and/or first relevant information of a first reference signal set to which a part of measurement results to be reported correspond, and/or a first time interval for transmitting an aperiodic measurement report, are configured for the terminal equipment, so that the terminal equipment is able to carry a part of the measurement results on the uplink channels in one time of measurement reporting feedback, thereby lowering the load of the uplink measurement feedback.

### Embodiments of a Second Aspect

The embodiments of this disclosure provide an information transceiving method, which shall be described from a terminal equipment side, an AI model being deployed at a network device side, with contents identical to those in the embodiments of the first aspect being not going to be described herein any further.

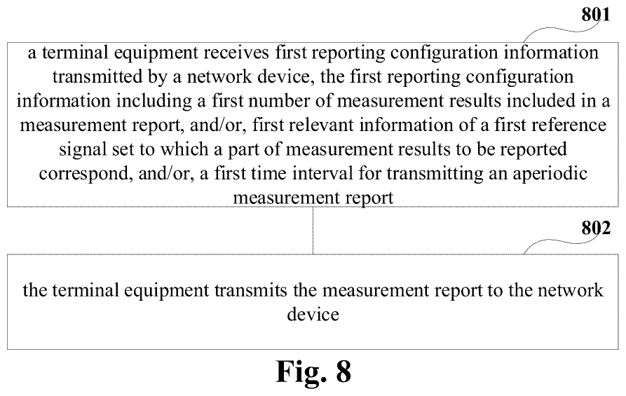

FIG. 8 is a schematic diagram of the information transceiving method of the embodiments of this disclosure. As shown in FIG. 8, the method includes:
801: a terminal equipment receives first reporting configuration information transmitted by a network device, the first reporting configuration information including a first number of measurement results included in a measurement report, and/or, first relevant information of a first reference signal set to which a part of measurement results to be reported correspond, and/or, a first time interval for transmitting an aperiodic measurement report; and
802: the terminal equipment transmits the measurement report to the network device.

It should be noted that FIG. 8 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 8.

In some embodiments, implementations of 801-802 correspond to those of 301-302, and shall not be repeated herein any further.

In some embodiments, the terminal equipment may determine the number of measurement results included in the measurement report and first reference signals to which the measurement results correspond, and may determine time units on which the measurement report is transmitted, according to the first reporting configuration information (in combined with the second reporting configuration information). For example, the number of measurement results included in a measurement report received on each time unit is determined according to the first number in the first reporting configuration information, an interval between adjacent time units is determined according to the first time interval and/or a reporting period in the first reporting configuration information, and the first reference signal set corresponding to the measurement result included in the measurement report received on each time unit is determined according to the first relevant information. Reference may be made to the embodiments of the first aspect for details, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiments, the first number of measurement results included in the measurement report, and/or first relevant information of a first reference signal set to which a part of measurement results to be reported correspond, and/or a first time interval for transmitting an aperiodic measurement report, are configured for the terminal equipment, so that the terminal equipment is able to carry a part of the measurement results on the uplink channels in one time of measurement reporting feedback, thereby lowering the load of the uplink measurement feedback.

The information transceiving methods between the terminal equipment and the network device in the embodiments of the first aspect and the embodiments of the second aspect are as described below.

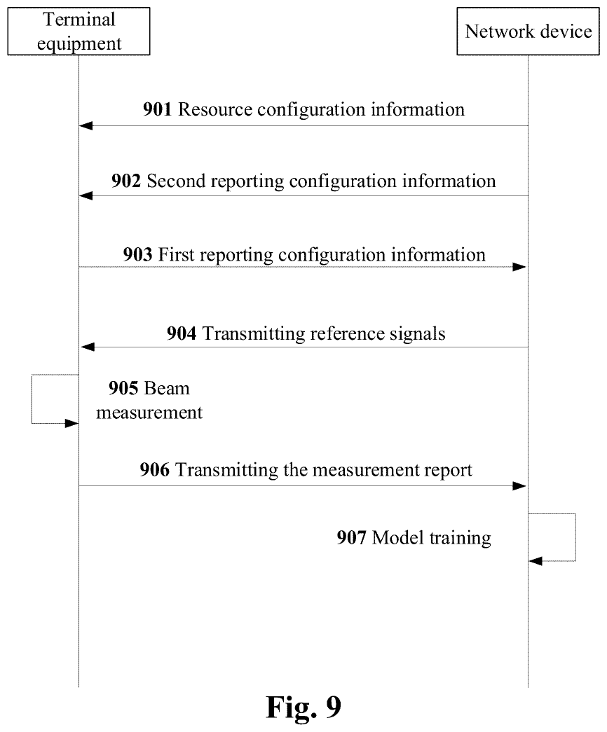

FIG. 9 is a schematic diagram of the information transceiving method in the embodiments of this disclosure. As shown in FIG. 9, the method includes:
901: the network device transmits resource configuration information to the terminal equipment;
902: the network device transmits second reporting configuration information to the terminal equipment;
903: the network device transmits first reporting configuration information to the terminal equipment;
904: the network device transmits reference signals in the reference signal set to the terminal equipment;
905: the terminal equipment uses the reference signals for beam measurement;
906: the terminal equipment transmits the measurement report to the network device; and
907: the network device feeds the measurement results in the measurement report as input into the AI model for training, so as to obtain training results.

In some embodiments, implementations of 901-903 are as described above, and implementation of the first reporting configuration information in 903 may be as described in (I) or (II). In 904, the terminal equipment may perform beam measurement on all reference signals in the reference signal set, and in 906, the terminal equipment determines which measurement results are included in a measurement report according to the first reporting configuration information.

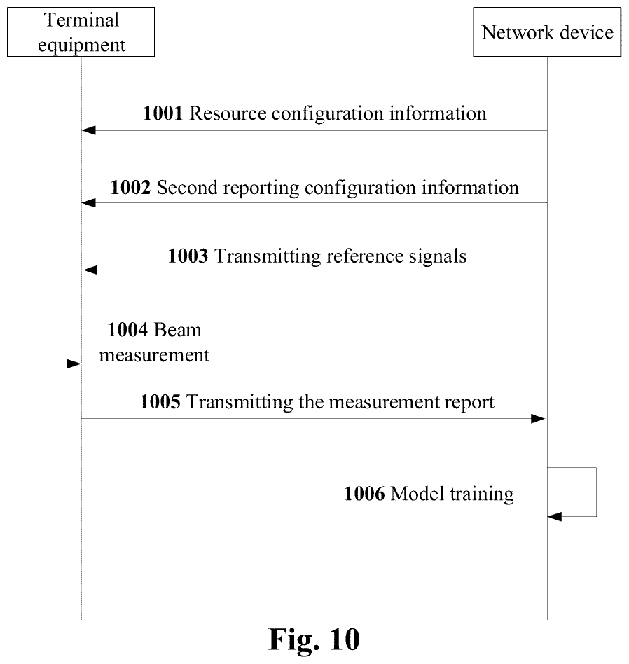

FIG. 10 is a schematic diagram of the information transceiving method in the embodiments of this disclosure. As shown in FIG. 10, the method includes:
1001: the network device transmits resource configuration information to the terminal equipment;
1002: the network device transmits second reporting configuration information (including the first reporting configuration information) to the terminal equipment;
1003: the network device transmits reference signals in the reference signal set to the terminal equipment;
1004: the terminal equipment uses the reference signals for beam measurement;
1005: the terminal equipment transmits the measurement report to the network device; and
1006: the network device feeds the measurement results in the measurement report as input into the AI model for training, so as to obtain training results.

Parts in FIG. 10 identical to those in FIG. 9 shall not be described herein, and a difference from FIG. 9 is that the network device includes the first reporting configuration information in the second reporting configuration information to transmit.

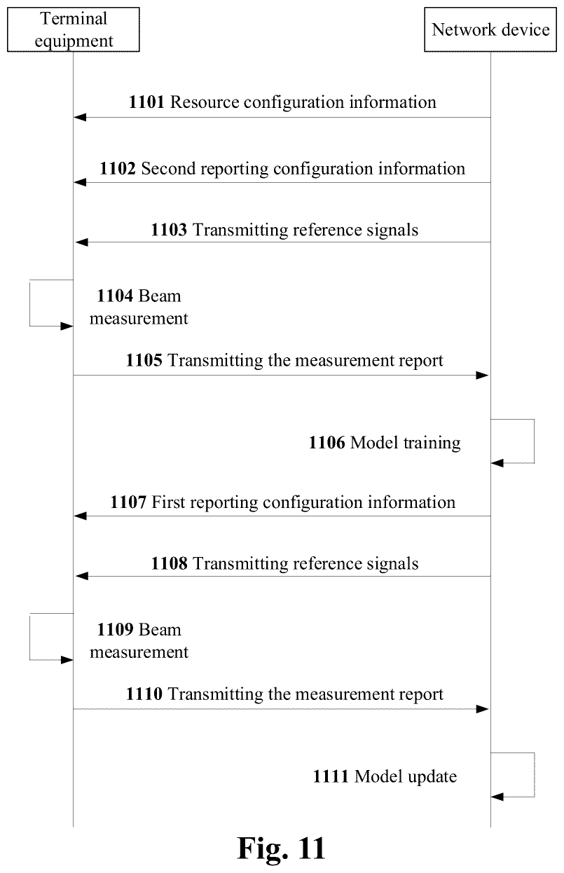

FIG. 11 is a schematic diagram of the information transceiving method in the embodiments of this disclosure. As shown in FIG. 11, the method includes:
1101: the network device transmits resource configuration information to the terminal equipment;
1102: the network device transmits (existing) second reporting configuration information to the terminal equipment;
1103: the network device transmits reference signals in the reference signal set to the terminal equipment;
1104: the terminal equipment uses the reference signals for beam measurement;
1105: the terminal equipment transmits the measurement report to the network device according to the second reporting configuration information;
1106: the network device feeds the measurement results in the measurement report as input into the AI model for training, so as to obtain training results;
1107: the network device transmits first reporting configuration information to the terminal equipment;
1108: the network device transmits reference signals in the reference signal set to the terminal equipment;
1109: the terminal equipment uses the reference signals for beam measurement;
1110: the terminal equipment transmits a measurement report of a part of the measurement results to the network device according to the first reporting configuration information; and
1111: the network device feeds the part of the measurement results in the measurement report as input into the AI model, so as to obtain a model update result.

The information transceiving method in FIG. 11 is applicable to scenarios where data required in training need to be updated due to that a currently-used model needs to be updated as the communication environment changes. Implementation of the first reporting configuration information in 1107 may be as described in (II). Optionally, the information transceiving methods in FIG. 9 and FIG. 10 may also include 1107-1111 when data required in training need to be updated after the model training is completed, which shall not be enumerated herein any further.

### Embodiments of a Third Aspect

The embodiments of this disclosure provide an information transceiving apparatus. The apparatus may be, for example, a terminal equipment, or one or some components or assemblies configured in the terminal equipment. Contents in the embodiments identical to those in the embodiments of the second aspect shall not be described herein any further.

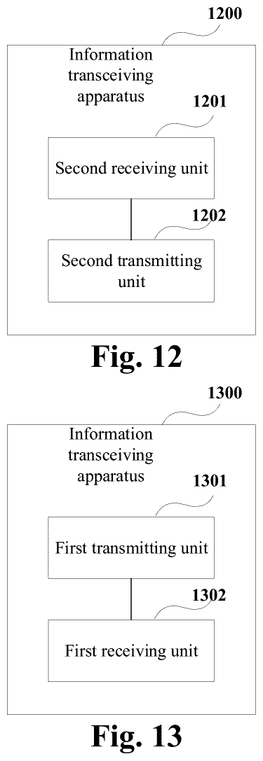

FIG. 12 is a schematic diagram of the information transceiving apparatus of the embodiments of this disclosure. As shown in FIG. 12, an information transceiving apparatus 1200 includes:
a second receiving unit 1201 configured to receive first reporting configuration information transmitted by a network device, the first reporting configuration information including a first number of measurement results included in a measurement report, and/or, first relevant information of a first reference signal set to which a part of measurement results to be reported correspond, and/or, a first time interval for transmitting an aperiodic measurement report; and
a second transmitting unit 1202 configured to transmit the measurement report to the network device.

In some embodiments, the second receiving unit 1201 is further configured to: receive second reporting configuration information transmitted by the network device, the second reporting configuration information including second relevant information of a reference signal set to which measurement results to be reported correspond, and the first reporting configuration is included or not included in the second reporting configuration information for transmission.

In some embodiments, the first relevant information includes a starting position of a sequence number of the first reference signal set in the reference signal set, and/or a bitmap of the first reference signal set corresponding to a reference signal set, and/or interval information of a sequence number of the first reference signal set in a reference signal set; and the first reference signal in the first reference signal set is one or more reference signals in the reference signal set.

In some embodiments, the first reporting configuration information is carried by RRC or an MAC CE or DCI.

In some embodiments, the second transmitting unit transmits the measurement reports on more than one time unit respectively.

In some embodiments, the number of measurement results included in a measurement report received on each time unit is determined according to the first number in the first reporting configuration information, and/or an interval between adjacent time units is determined according to the first time interval in the first reporting configuration information, and/or the first reference signal set corresponding to the measurement result included in the measurement report received on each time unit is determined according to the first relevant information.

In some embodiments, more than one measurement result included in the measurement report are ordered in a predetermined order, wherein the predetermined order includes an order of downlink transmitting beam identifiers first, and then downlink receiving beam identifiers, or an order of downlink receiving beam identifiers first, and then downlink transmitting beam identifiers.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 1200 may further include other components or modules, and reference may be made to related techniques for particulars of these components or modules.

Furthermore, for the sake of simplicity, connection relationships between the components or modules or signal profiles thereof are only illustrated in FIG. 12. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Fourth Aspect

The embodiments of this disclosure provide an information transceiving apparatus. The apparatus may be, for example, a network device, or one or some components or assemblies configured in the network device. Contents in the embodiments identical to those in the embodiments of the first aspect shall not be described herein any further.

FIG. 13 is a schematic diagram of the information transceiving apparatus of the embodiments of this disclosure. As shown in FIG. 13, an information transceiving apparatus 1300 includes:
a first transmitting unit 1301 configured to transmit first reporting configuration information to a terminal equipment, the first reporting configuration information including a first number of measurement results included in a measurement report, and/or, first relevant information of a first reference signal set to which a part of measurement results to be reported correspond, and/or, a first time interval for transmitting an aperiodic measurement report; and
a first receiving unit 1302 configured to receive a measurement report transmitted by the terminal equipment.

In some embodiments, the first transmitting unit 1301 is further configured to transmit second reporting configuration information to the terminal equipment, the second reporting configuration information including second relevant information of a reference signal set to which measurement results to be reported correspond, and the first reporting configuration is included or not included in the second reporting configuration information for transmission.

In some embodiments, the first relevant information includes a starting position of a sequence number of the first reference signal set in a reference signal set, and/or a bitmap of the first reference signal set corresponding to a reference signal set, and/or interval information of a sequence number of the first reference signal set in a reference signal set; and the first reference signal in the first reference signal set is one or more reference signals in the reference signal set.

In some embodiments, the first reporting configuration information is carried by RRC or an MAC CE or DCI.

In some embodiments, the first relevant information further includes an identifier of the reference signal set, and/or a first reporting configuration identifier, and/or a second reporting configuration identifier associated with the first reporting configuration.

In some embodiments, an AI model is deployed at the network device side.

In some embodiments, the first receiving unit respectively receives the measurement reports reported by the terminal equipment on more than one time unit.

In some embodiments, the number of measurement results included in a measurement report received on each time unit is determined according to the first number in the first reporting configuration information.

In some embodiments, an interval between adjacent time units is determined according to the first time interval in the first reporting configuration information.

In some embodiments, the first reference signal set corresponding to the measurement result included in the measurement report received on each time unit is determined according to the first relevant information.

In some embodiments, more than one measurement result included in the measurement report are ordered in a predetermined order.

In some embodiments, the predetermined order includes an order of downlink transmitting beam identifiers first, and then downlink receiving beam identifiers, or an order of downlink receiving beam identifiers first, and then downlink transmitting beam identifiers.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 1300 may further include other components or modules, and reference may be made to related techniques for particulars of these components or modules.

Furthermore, for the sake of simplicity, connection relationships between the components or modules or signal profiles thereof are only illustrated in FIG. 13. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Fifth Aspect

The embodiments of this disclosure provide a communication system, and reference may be made to FIG. 1, with contents identical to those in the embodiments of the first to the fourth aspects being not going to be described herein any further.

In some embodiments, the communication system 100 may at least include a network device 101 and/or a terminal equipment 102, the network device 101 including the information transceiving apparatus 1300 in the embodiments of the fourth aspect, and the terminal equipment 102 including the information transceiving apparatus 1200 in the embodiments of the third aspect, which shall not be repeated herein any further.

The embodiments of this disclosure further provide a network device, which may be, for example, a base station. However, this disclosure is not limited thereto, and it may also be another network device.

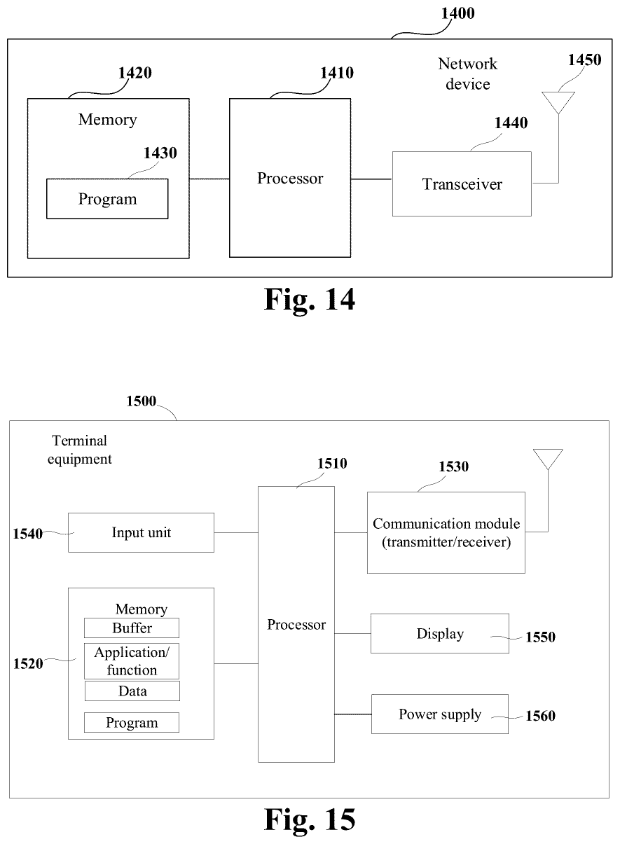

FIG. 14 is a schematic diagram of a structure of the network device of the embodiments of this disclosure. As shown in FIG. 14, a network device 1400 may include a processor 1410 (such as a central processing unit (CPU)) and a memory 1420, the memory 1420 being coupled to the processor 1410. The memory 1420 may store various data, and furthermore, it may store a program 1430 for information processing, and execute the program 1430 under control of the processor 1410.

For example, the processor 1410 may be configured to execute a program to carry out the information transceiving method described in the embodiments of the first aspect.

Furthermore, as shown in FIG. 14, the network device 1400 may include a transceiver 1440, and an antenna 1450, etc. Functions of the above components are similar to those in the related art, and shall not be described herein any further. It should be noted that the network device 1400 does not necessarily include all the parts shown in FIG. 14, and furthermore, the network device 1400 may include parts not shown in FIG. 14, and the related art may be referred to.

The embodiments of this disclosure further provide a terminal equipment; however, this disclosure is not limited thereto, and it may also be another equipment.

FIG. 15 is a schematic diagram of the terminal equipment of the embodiments of this disclosure. As shown in FIG. 15, a terminal equipment 1500 may include a processor 1510 and a memory 1520, the memory 1520 storing data and a program and being coupled to the processor 1510. It should be noted that this figure is illustrative only, and other types of structures may also be used, so as to supplement or replace this structure and achieve a telecommunications function or other functions.

For example, the processor 1510 may be configured to execute a program to carry out the information transceiving method as described in the embodiments of the second aspect.

As shown in FIG. 15, the terminal equipment 1500 may further include a communication module 1530, an input unit 1540, a display 1550, and a power supply 1560, wherein functions of the above components are similar to those in the related art, which shall not be described herein any further. It should be noted that the terminal equipment 1500 does not necessarily include all the parts shown in FIG. 15, and the above components are not necessary. Furthermore, the terminal equipment 1500 may include parts not shown in FIG. 15, and the related art may be referred to.

Embodiments of this disclosure provide a computer readable program, when executed in a terminal equipment, causes the terminal equipment to carry out the information transceiving method as described in the embodiments of the second aspect.

Embodiments of this disclosure provide a computer storage medium, including a computer readable program, which causes a terminal equipment to carry out the information transceiving method as described in the embodiments of the second aspect.

Embodiments of this disclosure provide a computer readable program, when executed in a network device, causes the network device to carry out the information transceiving method as described in the embodiments of the first aspect.

Embodiments of this disclosure provide a computer storage medium, including a computer readable program, which causes a network device to carry out the information transceiving method as described in the embodiments of the first aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An information transceiving method, applicable to a network device, characterized in that the method includes:
transmitting first reporting configuration information by the network device to a terminal equipment, the first reporting configuration information including a first number of measurement results included in a measurement report, and/or, first relevant information of a first reference signal set to which a part of measurement results to be reported correspond, and/or, a first time interval for transmitting an aperiodic measurement report; and
receiving, by the network device, a measurement report transmitted by the terminal equipment.

2. The method according to supplement 1, wherein the network device further transmits second reporting configuration information to the terminal equipment, the second reporting configuration information including second relevant information of a reference signal set to which measurement results to be reported correspond,
and the first reporting configuration is included or not included in the second reporting configuration information for transmission.

3. The method according to supplement 1 or 2, wherein the first relevant information includes a starting position of a sequence number of the first reference signal set in a reference signal set, and/or a bitmap of the first reference signal set corresponding to a reference signal set, and/or interval information of a sequence number of the first reference signal set in a reference signal set;
and the first reference signal in the first reference signal set is one or more reference signals in the reference signal set.

4. The method according to supplement 1, wherein the first reporting configuration information is carried by RRC or an MAC CE or DCI.

5. The method according to supplement 1, wherein the first relevant information further includes an identifier of the reference signal set, and/or a first reporting configuration identifier, and/or a second reporting configuration identifier associated with the first reporting configuration.

6. The method according to supplement 1, wherein an AI model is deployed at the network device side.

7. The method according to supplement 1, wherein the network device respectively receives the measurement reports reported by the terminal equipment on more than one time unit.

8. The method according to supplement 7, wherein the number of measurement results included in a measurement report received on one time unit is determined according to the first number in the first reporting configuration information.

9. The method according to supplement 7, wherein an interval between adjacent time units is determined according to the first time interval in the first reporting configuration information.

10. The method according to supplement 7, wherein the first reference signal set corresponding to the measurement result included in the measurement report received on one time unit is determined according to the first relevant information.

11. The method according to supplement 1, wherein more than one measurement result included in the measurement report are ordered in a predetermined order.

12. The method according to supplement 11, wherein the predetermined order includes an order of downlink transmitting beam identifiers first, and then downlink receiving beam identifiers, or an order of downlink receiving beam identifiers first, and then downlink transmitting beam identifiers.

13. An information transceiving method, applicable to a terminal equipment, characterized in that the method includes:
receiving, by the terminal equipment, first reporting configuration information transmitted by a network device, the first reporting configuration information including a first number of measurement results included in a measurement report, and/or, first relevant information of a first reference signal set to which a part of measurement results to be reported correspond, and/or, a first time interval for transmitting an aperiodic measurement report; and
transmitting the measurement report by the terminal equipment to the network device.

14. The method according to supplement 13, wherein the terminal equipment further receives second reporting configuration information transmitted by the network device, the second reporting configuration information including second relevant information of a reference signal set to which measurement results to be reported correspond,
and the first reporting configuration is included or not included in the second reporting configuration information for transmission.

15. The method according to supplement 13 or 14, wherein the first relevant information includes a starting position of a sequence number of the first reference signal set in the reference signal set, and/or a bitmap of the first reference signal set corresponding to a reference signal set, and/or interval information of a sequence number of the first reference signal set in a reference signal set;
and the first reference signal in the first reference signal set is one or more reference signals in the reference signal set.

16. The method according to supplement 13, wherein the first reporting configuration information is carried by RRC or an MAC CE or DCI.

17. The method according to supplement 13, wherein the terminal equipment transmits the measurement reports on more than one time unit respectively.

18. The method according to supplement 17, wherein the number of measurement results included in a measurement report received on one time unit is determined according to the first number in the first reporting configuration information, and/or an interval between adjacent time units is determined according to the first time interval in the first reporting configuration information, and/or the first reference signal set corresponding to the measurement result included in the measurement report received on one time unit is determined according to the first relevant information.

19. The method according to supplement 13, wherein more than one measurement result included in the measurement report are ordered in a predetermined order, wherein the predetermined order includes an order of downlink transmitting beam identifiers first, and then downlink receiving beam identifiers, or an order of downlink receiving beam identifiers first, and then downlink transmitting beam identifiers.

20. A network device, including a memory and a processor, the memory storing a computer program, and the processor being configured to execute the computer program to carry out the method as described in any one of supplements 1-12.

21. A terminal equipment, including a memory and a processor, the memory storing a computer program, and the processor being configured to execute the computer program to carry out the method as described in any one of supplements 13-19.

1. An information transceiving apparatus, applicable to a network device, the apparatus comprising:
a first transmitter configured to transmit first reporting configuration information to a terminal equipment, the first reporting configuration information comprising a first number of measurement results included in a measurement report, and/or, first relevant information of a first reference signal set to which a part of measurement results to be reported correspond, and/or, a first time interval for transmitting an aperiodic measurement report; and
a first receiver configured to receive a measurement report transmitted by the terminal equipment.

2. The apparatus according to claim 1, wherein the first transmitter is further configured to:
transmit second reporting configuration information to the terminal equipment, the second reporting configuration information comprising second relevant information of a reference signal set to which measurement results to be reported correspond,
and a first reporting configuration is included or not included in the second reporting configuration information for transmission.

3. The apparatus according to claim 1, wherein the first relevant information comprises a starting position of a sequence number of the first reference signal set in a reference signal set, and/or a bitmap of the first reference signal set corresponding to a reference signal set, and/or interval information of a sequence number of the first reference signal set in a reference signal set;
and the first reference signal in the first reference signal set is one or more reference signals in the reference signal set.

4. The apparatus according to claim 1, wherein the first reporting configuration information is carried by RRC or an MAC CE or DCI.

5. The apparatus according to claim 1, wherein the first relevant information further comprises an identifier of the reference signal set, and/or a first reporting configuration identifier, and/or a second reporting configuration identifier associated with a first reporting configuration.

6. The apparatus according to claim 1, wherein an AI model is deployed at the network device side.

7. The apparatus according to claim 1, wherein the first receiver respectively receives the measurement reports reported by the terminal equipment on more than one time unit.

8. The apparatus according to claim 7, wherein the number of measurement results included in a measurement report received on one time unit is determined according to the first number in the first reporting configuration information.

9. The apparatus according to claim 7, wherein an interval between adjacent time units is determined according to the first time interval in the first reporting configuration information.

10. The apparatus according to claim 7, wherein the first reference signal set corresponding to the measurement result included in the measurement report received on one time unit is determined according to the first relevant information.

11. The apparatus according to claim 1, wherein more than one measurement result included in the measurement report are ordered in a predetermined order.

12. The apparatus according to claim 11, wherein the predetermined order comprises an order of downlink transmitting beam identifiers first, and then downlink receiving beam identifiers, or an order of downlink receiving beam identifiers first, and then downlink transmitting beam identifiers.

13. An information transceiving apparatus, applicable to a terminal equipment, the apparatus comprising:
a second receiver configured to receive first reporting configuration information transmitted by a network device, the first reporting configuration information comprising a first number of measurement results included in a measurement report, and/or, first relevant information of a first reference signal set to which a part of measurement results to be reported correspond, and/or, a first time interval for transmitting an aperiodic measurement report; and
a second transmitter configured to transmit the measurement report to the network device.

14. The apparatus according to claim 13, wherein the second receiver is further configured to:
receive second reporting configuration information transmitted by the network device, the second reporting configuration information comprising second relevant information of a reference signal set to which measurement results to be reported correspond,
and a first reporting configuration is included or not included in the second reporting configuration information for transmission.

15. The apparatus according to claim 13, wherein the first relevant information comprises a starting position of a sequence number of the first reference signal set in the reference signal set, and/or a bitmap of the first reference signal set corresponding to a reference signal set, and/or interval information of a sequence number of the first reference signal set in a reference signal set;
and the first reference signal in the first reference signal set is one or more reference signals in the reference signal set.

16. The apparatus according to claim 13, wherein the first reporting configuration information is carried by RRC or an MAC CE or DCI.

17. The apparatus according to claim 13, wherein the second transmitter transmits the measurement reports on more than one time unit respectively.

18. The apparatus according to claim 17, wherein the number of measurement results included in a measurement report received on one time unit is determined according to the first number in the first reporting configuration information, and/or an interval between adjacent time units is determined according to the first time interval in the first reporting configuration information, and/or the first reference signal set corresponding to the measurement result included in the measurement report received on one time unit is determined according to the first relevant information.

19. The apparatus according to claim 13, wherein more than one measurement result included in the measurement report are ordered in a predetermined order, wherein the predetermined order comprises an order of downlink transmitting beam identifiers first, and then downlink receiving beam identifiers, or an order of downlink receiving beam identifiers first, and then downlink transmitting beam identifiers.

20. A communication system, comprising a terminal equipment and/or a network device,
the terminal equipment comprising an information transceiving apparatus comprising:
a second receiver configured to receive first reporting configuration information transmitted by a network device, the first reporting configuration information comprising a first number of measurement results included in a measurement report, and/or, first relevant information of a first reference signal set to which a part of measurement results to be reported correspond, and/or, a first time interval for transmitting an aperiodic measurement report; and
a second transmitter configured to transmit the measurement report to the network device, and
the network device comprising an information transceiving apparatus comprising:
a first transmitter configured to transmit first reporting configuration information to a terminal equipment, the first reporting configuration information comprising a first number of measurement results included in a measurement report, and/or, first relevant information of a first reference signal set to which a part of measurement results to be reported correspond, and/or, a first time interval for transmitting an aperiodic measurement report; and
a first receiver configured to receive a measurement report transmitted by the terminal equipment.
